(19) United States
(12) Patent Application Publication
(10) Pub. No.: US 2003/0222836 A1
(43) Pub. Date: Dec. 4, 2003

(54) Method and circuit for driving a liquid crystal display and liquid crystal display incorporating the same

(75) Inventor: Jia-Fam Wong, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU OPTRONICS CORP

(21) Appl. No.: 10/349,751

(22) Filed: Jan. 21, 2003

(30) Foreign Application Priority Data
May 28, 2002 (TW) 91111359

(51) Int. Cl. G09G 3/36

(52) U.S. Cl. 345/87

(57) ABSTRACT

A driving circuit of a liquid crystal display is provided. The circuit outputs a video signal to control a liquid crystal display panel having a plurality of display elements coupled to corresponding data electrodes and gate electrodes. A gate driver outputs scan signals to the gate electrodes. A data driver outputs the video signal responding to the image controlling signal to the data electrodes. The video signal has a first signal level and a second signal level corresponding to a first frame and a second frame, respectively. The video signal in a third frame has a first output signal higher than the second signal level and a second output signal substantially equal to the second signal level, and the video signal in a fourth frame has a third output signal lower than the first signal level and a fourth output signal substantially equal to the first signal level when the first signal level is lower than the second signal level.

### BACKGROUND OF THE INVENTION

1. Field of the Invention

The present invention relates generally to a method and a circuit for driving a liquid crystal display (LCD), and more particularly to a method and a circuit for switching the gray levels of a pixel in a LCD.

2. Description of the Related Art

While there are several types of liquid crystal displays (LCDs), all LCDs operate on similar general principles. A liquid crystal material is placed in a sealed but light transmissive chamber, and light transmissive electrodes are placed above and below the liquid crystal material. In one type of LCD utilizing what are called twisted nematic liquid crystals, when sufficient electric potential is applied between the electrodes, the liquid crystal molecules change their alignments. The change in alignment alters the polarization state of light passing through the liquid crystal material. The chamber or cell essentially acts as a light shutter or valve, letting a maximum, minimum or some intermediate levels of light traverses. These levels of light transmittance are called gray levels.

A matrix LCD structure is normally utilized for complex displays. A large number of very small independent regions of liquid crystal material are positioned in a plane. Each of these regions is generally called a picture element or pixel. These pixels are usually arranged in rows and columns forming a matrix. Corresponding numbers of column and row electrodes are correlated with the rows and columns of pixels. An electric potential, also called a driving force, can therefore be applied to any pixel by selection of appropriate row and column electrodes and then a desired graphic can be generated.

The amplitude of a driving force for a pixel solely depends on the gray level that the pixel is going to present. FIG. 1 is a schematic diagram of a prior art liquid crystal display panel (hereinafter, referred to as a “LCD panel”) and the peripheral driving circuits thereof. As shown in the figure, a LCD panel 1 is formed by interlacing data electrodes (represented by D1, D2, D3, . . . , Dm) and gate electrodes (represented by G1, G2, G3, . . . , Gm), each of the interlacing data electrodes and gate electrodes controlling a display unit. As an example, interlacing data electrode D1 and gate electrode G1 control the display unit 200. The equivalent circuit of each display unit comprises thin film transistors (TFTs) (Q11-Q1m, Q21-Q2m, . . . , Qn1-Qnm) and storage capacitors (C11-C1m, C21-C2m, . . . , Cn1-Cnm). The gates and drains of these TFTs are respectively connected to gate electrodes (G1-Gn) and data electrodes (D1-Dm). Such a connection can turn on/off all TFTs on the same line (i.e. positioned on the same scan line) using a scan signal of gate electrodes (G1-Gn), thereby controlling the video signals of the data electrodes to be written into the corresponding display unit. It is noted that a display unit only controls the brightness of a single pixel on the LCD panel.

Accordingly, each display unit responds to a single pixel on a monochromatic LCD while-each display unit responds to a single subpixel on a color LCD. The subpixel can be red (represented by “R”), blue (represented by “B”), or green (represented by “G”) . In other words, a single pixel is formed by a RGB (three display units) combination.

In addition, FIG. 1 also shows a part of the driving circuit of the LCD panel 1. Gate driver 10 outputs one or more scan signals (or referred to as scan pulses) of each of the gate electrodes G1, G2, . . . , Gn according to a predetermined sequence. When a scan signal is carried on one gate electrode, the TFTs within all display units on the same row or scan line are turned on while the TFTs within all display units on other rows or scan lines may be turned off. When a scan line is selected, data driver 20 outputs a video signal (gray value) to the m display units of the respective rows through data electrodes D1, D2, . . ., Dm according to the image data to be displayed. After gate driver 10 scans n rows continuously, the display of a single frame is completed. Thus, repeated scans of each scan line can achieve the purpose of continuously displaying an image. As shown in FIG. 1, signal CPV indicates the clock of the gate driver 10, signal CTR indicates the scan control signal received by the gate driver 10, signal LD indicates a data latch signal of the data driver 20, and signal DATA indicates the image signal received by the data driver 20.

Typically, a video signal, which is transferred by the data electrodes D1, D2, . . . , Dm, is divided into a positive video signal and a negative video signal based on the relationship with the common electrode voltage VCOM. The positive video signal indicates the signal having a voltage level higher than the voltage VCOM, and based on the gray value represented, the actually produced potential of the signal ranges between voltages Vp1 and Vp2. In general, a gray value is lower if it is closer to the common electrode voltage VCOM. On the other hand, the negative video signal indicates that the signal has a voltage level lower than the voltage VCOM, and based on the gray value represented, the actually produced potential of the signal ranges between voltages Vn1 and Vn2. Also, the gray value is lower if it is closer to the common electrode voltage VCOM. When a gray value is represented, whether in a positive or negative video signal, the display effect is substantially the same.

In order to prevent the liquid crystal molecule from continuously receiving a single-polar bias voltage so as to reduce the life span of liquid crystal molecules, a display unit alternately receives positive and negative polar video signals corresponding to odd and even frames.

FIG. 2A shows a timing chart of the voltage difference of a liquid crystal with respect to each frame. FIG. 2A shows the timing of an original video signal. The frame rate is 60 Hz, and thus the frame time is 16.6 ms. The voltage difference between the liquid crystals gradually reaches to the applied voltage as shown by the dotted line.

FIG. 2B shows another timing chart of the voltage difference of a liquid crystal with respect to each frame. FIG. 2B shows the timing of an over driven video signal of FIG. 2A. The level of the video signal is adjusted according to the displayed frames to increase the rotation rate of the liquid crystal molecules to display real gray levels.

However, conventional overdriving is unable to provide correct voltage to the liquid crystals when the frame rate is increasing. The excessive charge or discharge of the liquid crystal will cause a display error. Additional hardware and more complicated calculations are inevitably employed to obtain the correct voltage of liquid crystal by conventional overdriving.

### SUMMARY OF THE INVENTION

The object of the present invention is to provide a method and a circuit for driving a liquid crystal display (LCD) by overdriving to increase the rotation rate of liquid crystal molecules, and to correctly control the voltage provided to the liquid crystal molecules.

To achieve the above object, the present invention provides a driving circuit of a liquid crystal display for outputting a video signal according to an image controlling signal provided by a host to control a liquid crystal display panel having a plurality of display elements coupled to responding data electrodes and gate electrodes. A gate driver outputs scan signals to the gate electrodes. A data driver outputs the video signal responding to the image-controlling signal to the data electrodes. The video signal comprises a first signal level and a second signal level responding to a first frame and a second frame, respectively. The video signal in the third frame comprises a first output signal higher than the second signal level and a second output signal substantially equal to the second signal level, and the video signal in the fourth frame comprises a third output signal lower than the first signal level and a fourth output signal substantially equal to the first signal level when the first signal level is lower than the second signal level.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a schematic diagram of a prior art liquid crystal display panel and the associated peripheral driving circuit.

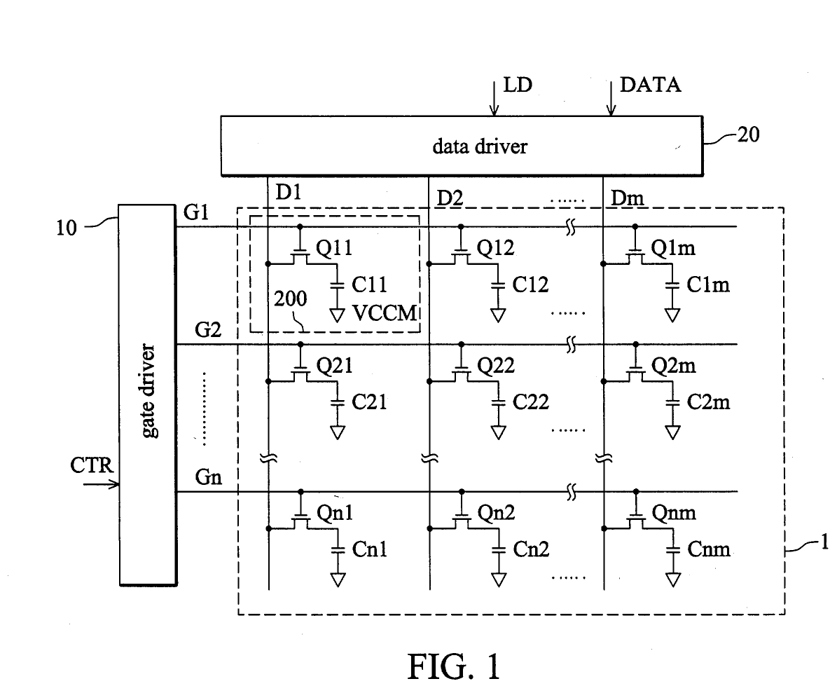

FIG. 2A shows the timing chart of the voltage difference of a liquid crystal with respect to each frame.

FIG. 2B shows the timing chart of the voltage difference of a liquid crystal with respect to each frame by conventional overdriving.

FIG. 3 is a schematic diagram of a liquid crystal display according to one embodiment of the present invention.

FIG. 4 shows the timing chart of the voltage difference of a liquid crystal with respect to each frame by overdriving according to one embodiment of the present invention.

### DETAILED DESCRIPTION OF THE INVENTION

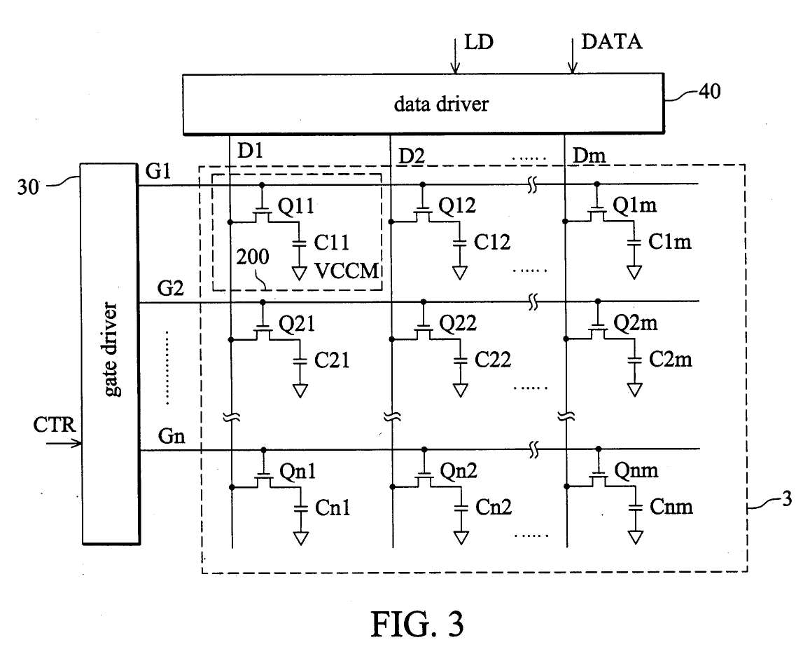

FIG. 3 is a schematic diagram of a liquid crystal display according to one embodiment of the present invention. As shown in the figure, a LCD panel 3 is formed by interlacing data electrodes (represented on D1, D2, D3, . . . , Dm) and gate electrodes (represented on G1, G2, G3, . . . , Gm), each interlacing data electrode and gate electrode controlling a display unit. As an example, interlacing data electrode D1 and gate electrode G1 control the display unit 300. The equivalent circuit of each display unit comprises thin film transistors (TFTs) (Q11-Q1m, Q21-Q2m, . . . , Qn1-Qnm) and storage capacitors (C11-C1m, C21-C2m, . . . , Cn1-Cnm). The gate and drain of TFTs are respectively connected to gate electrodes (G1-Gn) and data electrodes (D1-Dm). Such a connection can turn on/off all TFTs on the same line (i.e. positioned on the same scan line) using a scan signal of the gate electrodes (G1-Gn), thereby controlling the video signal of data electrodes to be written into the corresponding display units. It is noted that a display unit can only controls the brightness of a single pixel on the LCD panel. Accordingly, each display unit responds to a single pixel on a monochromatic LCD while each display unit responds to a single subpixel on a color LCD. The subpixel can be red (represented by “R”), blue (represented by “G”), or green (represented by “G”). In other words, a single pixel is formed by a RGB (three display units) combination.

In addition, FIG. 3 also shows a part of the driving circuit of the LCD panel. Gate driver 30 outputs the scan signals (or referred to as a scan pulse) of each of the gate electrodes G1, G2, . . . , Gn according to a predetermined sequence. When a scan signal is carried on one gate electrode, the TFTs within all display units on the same row or scan line are turned on while the TFTs within all display units on other rows or scan lines may be turned off. When a scan line is selected, data driver 40 outputs a video signal (gray value) to the m display units of the respective rows through data electrodes D1, D2, . . . , Dm according to the image data to be displayed.

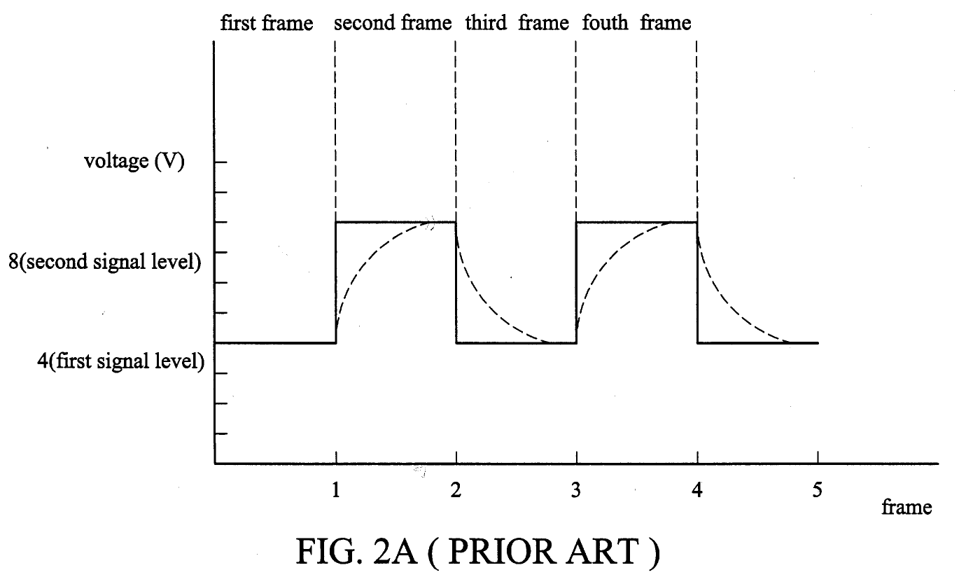

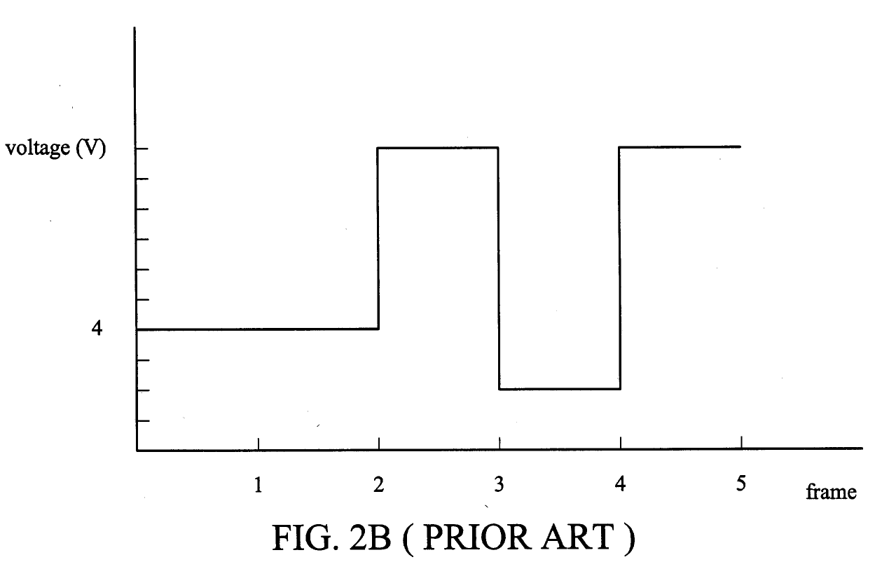

As mentioned above, FIG. 2A shows a timing chart of the voltage difference of a liquid crystal with respect to each frame. FIG. 2A shows the timing of an original video signal. The frame rate is 60 Hz, and thus the frame time is 16.6 ms.

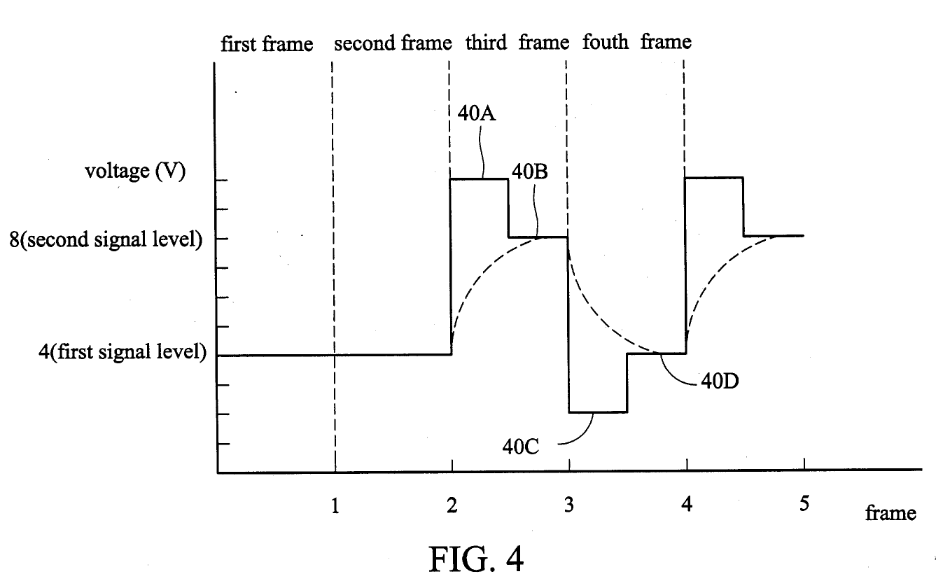

According to the present invention, the original video signal is transformed by overdriving according to the voltage level of the video signal in the first frame and the second frame. The transformed video signal is provided to the third frame. The waveform of the transformed video signal is shown in the FIG. 4.

FIG. 4 shows the timing chart of the voltage difference of a liquid crystal with respect to each frame by overdriving according to the present invention. In FIG. 2A, the video controlling signals of the video signal in the first frame and the second frame are the first signal level and the second signal level, respectively. Here, the first signal level is lower than the second signal level: Therefore, according to the present invention, the sequential video signals output by the data driver 40 in the third frame are a first output signal 40A higher than the second signal level and a second output signal 40B having the second signal level, as shown in FIG. 4. And the sequential video signals output by the data driver 40 in the fourth frame are a third output signal 40C lower than the first signal level and a fourth output signal 40D having the first signal level.

According to the waveform of the video signal of the present invention, there are two steps to apply the voltage difference between the liquid crystal by the video signal, for example, 8 V. First, in the first half of the frame time, with the third frame as an example, the first output signal higher than 8 V is provided by overdriving to charge the liquid crystal, with 10 V as an example. Therefore, the charging rate of the liquid crystal is increased. Then, in the second half of the third frame, the second output signal substantially equal to 8 V is provided to charge the liquid crystal to avoid overdriving and continue charging the liquid crystal not yet reaching the target gray level. Similarly, when the polarity of the liquid crystal changes, there are two steps to apply the voltage difference between the liquid crystal by the video signal, with 4 V as an example. First, in the first half of the fourth frame, the third output signal lower than 4 V is provided by overdriving to discharge the liquid crystal, with 2 V as an example. Therefore, the discharging rate of the liquid crystal is increased. Then, in the second half of the fourth frame, the fourth output signal substantially equal to 4 V is provided to charge the liquid crystal to avoid overdriving and continue charging or discharging the liquid crystal to reach the target gray level.

After the gate driver 30 scans n rows continuously, the display of a single frame is completed. Thus, repeated scans of each scan line can achieve the purpose of continuously displaying an image. Signal CPV indicates the clock of the gate driver 30, signal CTR indicates the scan control signal received by the gate driver 30, signal LD indicates a data latch signal of the data driver 40, and signal DATA indicates the image signal received by the data driver 40.

According to the method and circuit of the present invention, the images are displayed according to the video controlling signal provided by a host. In one embodiment, the video signals provided to the data driver 40 have the effect of overdriving and are able to prevent the error display caused by the excessive charging or discharging of liquid crystals when using conventional overdriving. In addition, overdriving according to the present invention is performed without adding new elements, which is amenable for use in industry.

The foregoing description of the preferred embodiments of this invention has been presented for purposes of illustration and description. Other modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A driving circuit of a liquid crystal display for outputting a video signal according to an image controlling signal provided by a host to control a liquid crystal display panel, the liquid crystal display panel having a plurality of display elements coupled to corresponding data electrodes and gate electrodes, the driving circuit comprising:
a gate driver for outputting scan signals to the gate electrodes; and
a data driver for outputting the video signal responding to the image controlling signal to the data electrodes, wherein the video signal comprises a first signal level and a second signal level respectively responding to a first frame and a second frame, the video signal in a third frame comprises a first output signal higher than the second signal level and a second output signal substantially equal to the second signal level, and the video signal in a fourth frame comprises a third output signal lower than the first signal level and a fourth output signal substantially equal to the first signal level when the first signal level is lower than the second signal level.

2. The driving circuit of a liquid crystal display according to claim 1, wherein the levels of the first output signal and the third output signal are defined according the relation between the first signal level and the second signal level.

3. The driving circuit of a liquid crystal display according to claim 2, wherein the widths of the first output signal, the second output signal, the third output signal and the fourth output signal are substantially the same.

4. A liquid crystal display for displaying images according to an image controlling signal provided by a host, comprising:
a liquid crystal display panel having a plurality of display elements coupled to corresponding data electrodes and gate electrodes;
a gate driver for outputting scan signals to the gate electrodes; and
a data driver for outputting the video signal responding to the image controlling signal to the data electrodes, wherein the video signal comprises a first signal level and a second signal level respectively responding to a first frame and a second frame, the video signal in a third frame comprises a first output signal higher than the second signal level and a second output signal substantially equal to the second signal level, and the video signal in a fourth frame comprises a third output signal lower than the first signal level and a fourth output signal substantially equal to the first signal level when the first signal level is lower than the second signal level.

5. The liquid crystal display according to claim 4, wherein the levels of the first output signal and the third output signal are defined according the relation between the first signal level and the second signal level.

6. The liquid crystal display according to claim 5, wherein the widths of the first output signal, the second output signal, the third output signal and the fourth output signal are substantially the same.

7. A method of driving a liquid crystal display for outputting a video signal according to an image controlling signal provided by a host to control a liquid crystal display panel, the liquid crystal display panel having a plurality of display elements coupled to corresponding data electrodes and gate electrodes, the method comprising the steps of:
outputting scan signals to the gate electrodes; and
outputting the video signal responding to the image controlling signal to the data electrodes, wherein the video signal comprises a first signal level and a second signal level respectively responding to a first frame and a second frame, the video signal in a third frame comprises a first output signal higher than the second signal level and a second output signal substantially equal to the second signal level, and the video signal in a fourth frame comprises a third output signal lower than the first signal level and a fourth output signal substantially equal to the first signal level when the first signal level is lower than the second signal level.

8. The method according to claim 7, wherein the levels of the first output signal and the third output signal are defined according the relation between the first signal level and the second signal level.

9. The method according to claim 8, wherein the widths of the first output signal, the second output signal, the third output signal and the fourth output signal are substantially the same.
